(19) United States
(12) Patent Application Publication
(10) Pub. No.: US 2024/0253047 A1
(43) Pub. Date: Aug. 1, 2024

(54) A SYRINGE-PLUG AND A CARTRIDGE FOR ANALYTIC ASSAYS COMPRISING SUCH A SYRINGE-PLUG

(71) Applicant: Bacteromic Sp. z o.o., Warszawa (PL)

(72) Inventors: Radoslaw MILCZAREK, Warszawa (PL); Maria ZUZGA, Warszawa (PL); Pawel MICHALAK, Radom (PL); Seweryn BAJER-BORSTYN, Warszawa (PL)

(21) Appl. No.: 18/561,414

(22) PCT Filed: May 17, 2022
(86) PCT No.: PCT/IB2022/054566

§ 371 Date: Nov. 16, 2023

(30) Foreign Application Priority Data
May 18, 2021 (EP) 21174363.8

(51) Int. Cl. B01L 3/00

(52) U.S. Cl. CPC B01L 3/50825; B01L 3/502715; B01L 3/502723; B01L 3/523; B01L 2200/027; B01L 2200/0673; B01L 2200/0689; B01L 2300/042; B01L 2300/047; B01L 2300/049; B01L 2400/0478; B01L 2400/0683

(57) ABSTRACT

A syringe-plug (1, 1a, 1b, 1c, 1d) for placement in a sample chamber inlet of a cartridge for analytic assays, the syringe-plug comprising a tank (2) pre-filled with a liquid, the tank (2) having a proximal end (2a) and a distal end (2b), the proximal end (2a) of the tank (2) being closed by a piston (3) movable towards said distal end (2b), the distal end (2b) of the tank (2) being closed by a pierceable membrane (6) and the piston (3) being provided on its distal end (2b) side with a rod (4) having a piercing part (5) at its end enabling to pierce the membrane (6), wherein the proximal end (2a) of the tank (2) is provided with a plug part (7) surrounding the proximal end (2a) of the tank (2), the plug part (7) comprising external sealing means in the form of: at least one retaining rib (7b) surrounding a part of the plug part (7) circumference and comprising at least one gap (8b): at least one scaling rib (7c) surrounding the whole plug part (7) circumference: a thrust flange (7d) extending to the outside of the plug part (7) by a distance larger than the retaining rib(s) (7b) and the sealing rib(s) (7c), said sealing means being arranged sequentially as seen from the distal end (2b) side of the tank (2). A cartridge (11) for analytic assays comprising a sample chamber (10, 10a) integrated with a microfluidic system (9), the microfluidic system (9) being fed with a sample of analyte (S) and with a separating liquid (L), the sample chamber (10, 10a) having an inlet (13) adapted for insertion of the sample of analyte (S), and the cartridge further comprising a syringe-plug according to the invention.

The subject of the invention is a syringe-plug and a cartridge for analytic assays.

The invention relates to the domain of analytic assays, in particular microbiological assays including microbial identification and antimicrobial susceptibility testing. Determination of antimicrobial resistance of many microbes requires culturing of said microbes, exposing them to defined agents and monitoring their growth.

### STATE OF THE ART

Microfluidic systems are known comprising a set of incubation chambers (also called incubation wells) and networks of channels connected in a strictly defined way. By means of such sets located on plates or cartridges, it is possible to conduct reactions in the incubation chambers that may be reached through said channels.

EP3546067 discloses a microfluidic system consisting of two main surfaces, designed for conducting microbiological assays. The system (called a microfluidic chip) comprises a network of microchannels leading to numerous incubation chambers, a sample chamber and a separate chamber for a separating liquid. One system may accommodate even more than 2000 sample chambers.

Once the incubation segments have been filled with the sample, the separating liquid flows into the microfluidic channels, preventing cross-contamination between the segments. The flow of the separating liquid may be controlled by means of a valve, e.g. a wax valve, to be controlled from the outside. The valve separates the sample reservoir from the chamber containing the separating liquid and it melts at a temperature equal or greater than 37° C.

The above mentioned microfluidic system further comprises a releasable liquid-/gas-tight valve separating the liquid chamber from the microfluidic channels and the incubation chambers. The filling of the channels is realized through pressure changes, in any suitable container, possibly an exsiccator, a dedicated device for filling one microfluidic chip or many microfluidic chips simultaneously, or in any other device adapted to generate a pressure lower than the external pressure.

Such a configuration of the microfluidic system, the sample chamber and the separating liquid chamber results in that a diagnostician conducting an assay must perform many operations. Both the sample and the separating liquid must be introduced into the sample chamber 13 individually and by hand. Once filled, the sample chamber and the separating liquid chamber are being closed by two separate rubber caps. The manual filling of the separating liquid is cumbersome; the number of manual operations performed by the diagnostician is increased which generates opportunities for errors resulting from measuring an improper volume of the liquid, pipetting into a wrong chamber or not closing the chambers upon filling.

The small inlet of the separating liquid chamber makes it difficult to dose a highly viscous separating liquid. Individual storing of the separating liquid involves potential risk of contamination or spilling. There is also a risk of accidental melting of the wax valve and a resulting chemical reaction of the wax with the separating liquid. Moreover, the injection moulded microfluidic plate without an integrated sample chamber, and having a removable upper wall poses a risk of leaks.

### AIM OF THE INVENTION

The aim of the invention is to eliminate the above mentioned disadvantages associated with manual introduction of the separating liquid by a diagnostician and to improve stability and reliability related to the operation of the system.

Accordingly, the aim of the invention is to provide a syringe-plug pre-filled with a separating liquid, the syringe-plug being designed in particular for placement in a cartridge for analytic assays in order to introduce the separating liquid into a microfluidic system of the cartridge.

The aim of the invention is also to provide a cartridge for analytic assays having a microfluidic system adapted to be filled with the separating liquid by means of a syringe-plug pre-filled with a separating liquid.

### SUMMARY OF THE INVENTION

According to the invention a syringe-plug is provided for placement in a sample chamber of a cartridge for analytic assays, the syringe-plug comprising a tank pre-filled with a liquid, the tank having a proximal end and a distal end, the proximal end of the tank being closed by a piston movable towards said distal end, the distal end of the tank being closed by a pierceable membrane and the piston being provided on the distal end side with a rod having a piercing part at its end enabling to pierce the membrane.

The syringe-plug according to the invention is characterized in that the proximal end of the tank is provided with a plug part surrounding the proximal end of the tank, the plug part comprising external sealing means in the form of: at least one retaining rib surrounding a part of the plug part circumference and comprising at least one gap; at least one sealing rib surrounding the whole plug part circumference; a thrust flange extending to the outside of the plug part by a distance larger than the retaining rib(s) and the sealing rib(s), said sealing means being arranged sequentially as seen from the distal end side of the tank.

Preferably, each retaining rib comprises two mutually opposite gaps.

Preferably, each retaining rib and each sealing rib are susceptible to plastic/elastic deformations.

The plug part may further comprise at least one guiding rib located upstream of said at least one retaining rib as seen from the distal end side of the tank, the guiding rib surrounding a part of the plug part and comprising at least one gap and extending to the outside of the plug part by a distance smaller than said at least one retaining rib.

The plug part preferably comprises two sealing ribs.

The plug part may also comprise two guiding ribs.

Preferably, the piston rod has a cross-shaped cross-section over at least a part of its length, at least one arm of the cross comprising at least one indentation.

The piercing part of the rod preferably has a shape of a cone.

The piercing part of the rod may also have a shape of a cylinder with a slanted end.

According to the invention a cartridge for analytic assays is provided comprising a sample chamber integrated with a microfluidic system, the microfluidic system being fed with a sample of analyte and with a separating liquid, the sample chamber having an inlet adapted for insertion of the sample of analyte, the cartridge further comprising a syringe-plug according to the invention comprising a tank pre-filled with the separating liquid.

Preferably, the sample chamber has an outlet at its end opposite to the inlet, the outlet communicating with the microfluidic system for feeding the sample of analyte and the separating liquid into said microfluidic system.

The tank is preferably adapted to take a first position or a second position in the sample chamber, wherein in the first position the plug part partly closes the inlet of the sample chamber, and in the second position the plug part tightly closes the inlet of the sample chamber.

Preferably, each retaining rib and each sealing rib are susceptible to plastic/elastic deformations.

The plug part may further comprise at least one guiding rib located upstream of said at least one retaining rib as seen from the distal end side of the tank, the guiding rib surrounding a part of the plug part and comprising at least one gap and extending to the outside of the plug part by a distance smaller than said at least one retaining rib.

Preferably, the plug part comprises two sealing ribs.

The plug part may comprise two guiding ribs.

The piston rod of the syringe-plug may have a cross-shaped cross-section over at least a part of its length, at least one arm of the cross comprising at least one indentation.

The piercing part of the piston rod preferably has a shape of a cone corresponding to the shape of the outlet of the sample chamber, so as to constitute a tight closure of said outlet.

The piercing part of the rod preferably has a shape of a cylinder with a slanted end.

The syringe-plug according to the present invention allows to enclose the separating liquid in the tank in a temporarily gas-permeable way, and then to introduce it to the sample chamber surrounding the syringe-plug, the sample chamber being closed by the plug part of the syringe-plug. Said sample chamber may be in particular the sample chamber of the cartridge for analytic assays.

Therefore, with the use of the cartridge for analytic assays according to the present invention, there is no need to use either additional containers for supplying the separating liquid or valves or actuators having various functions. This is because the cartridge is filled through the sample chamber integrated therewith, the sample chamber being used for introducing both the analyte sample and the separating liquid (with the aid of the syringe-plug). An adequate volume of the separating liquid is introduced into the syringe-plug in advance and it is tightly enclosed within the same. It is enough to place the cartridge in an environment where appropriate pressure values can be obtained. The microfluidic system of the cartridge is first filled with the sample and then with the separating liquid by means of one actuator and by application of defined sequences of pressure changes.

Hence, due to the present invention, the filling of the microfluidic system with the separating liquid is automatic which eliminates possible errors during the filling. It also makes it possible to reduce the number of operations performed by a diagnostician.

### SHORT DESCRIPTION OF THE DRAWINGS

FIG. 1 shows a perspective exploded view of the syringe-plug according to a first embodiment of the present invention;

FIG. 2 shows a side view of the assembled syringe-plug of FIG. 1;

FIG. 3 shows a perspective view of the microfluidic system integrated with the sample chamber of the cartridge according to the present invention;

FIG. 4a shows a longitudinal section of the empty sample chamber before the sample of analyte and the syringe-plug have been introduced therein;

FIG. 4b shows a longitudinal section of the syringe-plug of FIGS. 1 and 2, ready to be introduced into the sample chamber;

FIG. 4c shows a longitudinal section of the sample chamber after the first step of introduction of the syringe-plug has been completed;

FIG. 4d shows a longitudinal section of the sample chamber after the first step of introduction of the syringe-plug has been completed and the membrane has been pierced;

FIG. 4e shows a longitudinal section of the sample chamber after the second step of introduction of the syringe-plug of FIGS. 1 and 2 has been completed and the outlet of the sample chamber has been closed;

FIG. 5 shows a more detailed longitudinal section of an upper part of the sample chamber after the first step of introduction of the syringe-plug of FIG. 1 has been completed;

FIGS. 6a and 6b show in a perspective view two variants of the plug part of the syringe-plug

FIG. 7a shows a fragment of an optional variant of the sample chamber;

FIG. 7b shows an enlarged detail A indicated in FIG. 7a;

FIG. 8 shows a longitudinal section of the sample chamber with the syringe-plug according to a second embodiment;

FIG. 9 shows a longitudinal section of the sample chamber with the syringe-plug according to a third embodiment;

FIG. 10 shows a longitudinal section of an upper part of the syringe-plug according to a fourth embodiment;

FIG. 11 shows a longitudinal section of a fragment of the sample chamber with the syringe-plug according to a fifth embodiment.

### DETAILED DESCRIPTION OF EMBODIMENTS OF THE INVENTION

The syringe-plug 1 according to the present invention is designed for being placed in an inlet 13 of a sample chamber 10 of a cartridge 11 for analytic assays. As may be seen in FIG. 1 showing the first embodiment of the invention, the syringe-plug 1 comprises a substantially cylindrical tank 2 and a piston 3 provided with a rod 4 ending with a piercing part 5. The rod 4 at least over a part of its length preferably has a cross-shaped cross section with four arms 4a. Every arm 4a preferably has at least one indentation 4b. The tank 2 has a proximal end 2a closed with a piston 3 and a distal end 2b on the side of the piercing part 5. The piston 3 may be moved towards the distal end 2b by an external force. The distal end 2b of the tank 2 is closed by a membrane 6. The proximal end 2a of the tank 2 is surrounded on its outside by a plug part 7. The plug part 7 is adapted to tightly close the inlet 13 of the sample chamber 10 against a liquid. In this embodiment the plug part 7 is equipped with external sealing means 7b, 7c enabling to partly close the inlet 13 so that at least one channel is formed letting the air flow through, or to totally close the inlet 13 in a tight manner.

The assembly of the syringe-plug 1 starts with introduction of the piston 3 with the rod 4 in the tank 2. Then the tank 2 is being filled with a measured volume of the separating liquid L which is non-polar liquid. Finally, the tank 2 is being closed by welding the membrane 6 on its distal end 2b. Preferably, the membrane 6 is made of an aluminum foil one-side coated by polypropylene.

The volume of the separating liquid L for filling the tank of the syringe-plug is defined experimentally so that the separating liquid L fills the microfluidic system properly. Before the membrane 6 is welded to the positioned upside down tank 2, the tank is not filled completely so that a gap e.g. about 1.5 mm is left by the distal end 2b edge of the tank. This makes it possible to weld the membrane; the oily liquid present on the edge would make the welding impossible. Also, thermal effects resulting from the membrane welding process (minor deformations of the tank outlet) require a free space to be left over the liquid surface next to the distal end 2b.

Upon assembly, the syringe-plug 1 is sterilized and enclosed in a sterile packaging. In this form it is ready for use when unpacked.

It may be envisaged that the syringe-plug according to the present invention is filled with another liquid depending on application. Accordingly, filling the syringe-plug with a non-polar separating liquid should be considered as non-limiting the scope of the invention.

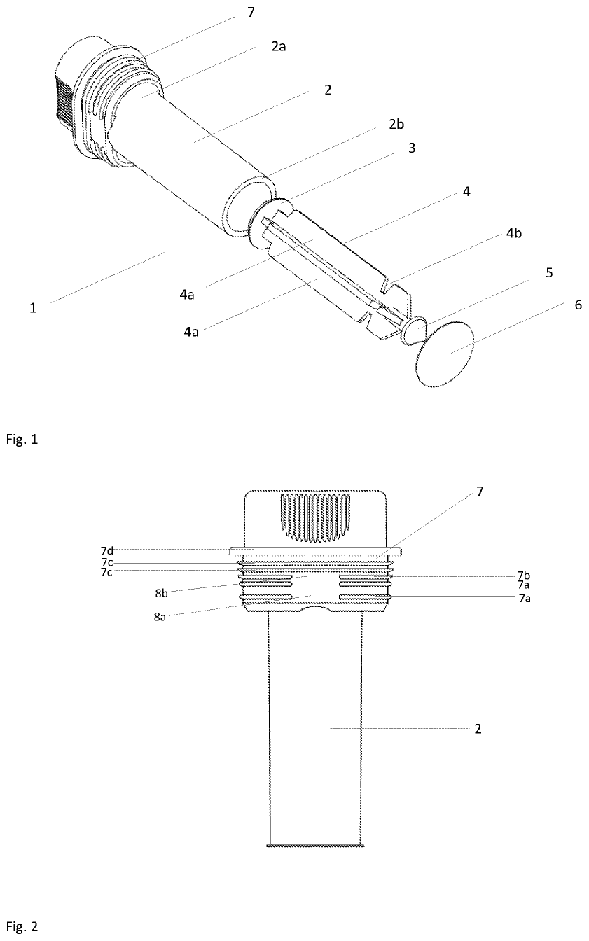

FIG. 2 shows a side view of the assembled syringe-plug according to the first embodiment of the invention. In this figure an exemplary plug part 7 is shown, surrounding the proximal end 2a of the tank 2. In this embodiment the tank 2 has a cylindrical cross-section but other suitable shapes of the cross-section are also possible.

The plug part 7 is in the form of a flange and it is provided with sealing means—as shown in FIG. 2—constituting in this embodiment, arranged sequentially as seen from the distal end 2b side of the tank 2: one retaining rib 7b, two sealing ribs 7c and one thrust flange 7d. Optional guiding ribs 7a and the retaining rib 7b surround only a part of the circumference of the plug part 7 as they comprise gaps 8a and 8b respectively. The gaps 8a and 8b are visible in FIG. 2 on one side of the tank, but preferably the guiding ribs 7a and the retaining rib 7b have two gaps 8a and 8b each, arranged on opposite sides of the tank. The two sealing ribs 7c and the thrust flange 7d, both surrounding the whole circumference of the plug part, are located above the retaining rib 7b.

In this embodiment the plug part 7 has also (optional) the guiding ribs 7a extending to the outside of the plug part 7 by a distance smaller than the other ribs; they have a rounded cross-section of a half-roll type shape. The guiding ribs 7a are not indispensable but at least one guiding rib 7a is desirable for the reasons explained below.

There is one retaining rib 7b on the circumference of the plug part 7 shown in FIG. 2, but there may be more of the retaining ribs 7b. The retaining rib 7b has a substantially triangular cross-section with a sharp end. The two sealing ribs 7c shown have the same cross-section, and there may also be at least one sealing rib. This shape of the cross-sections results in that the retaining rib 7b and the sealing ribs 7c are susceptible to plastic/elastic deformations. The ribs 7b and 7c extend to the outside of the plug part 7 by a distance larger than the guiding rib 7a.

The thrust flange 7d is located on the proximal end 2a side of the plug part 7. The retaining flange 7d extends to the outside of the plug part 7 by the largest distance. The function of all ribs will be described below.

The plug part 7 has a generally rounded, e.g. oval, cross-section so that it surrounds the cylindrical tank 2, partially abutting against it.

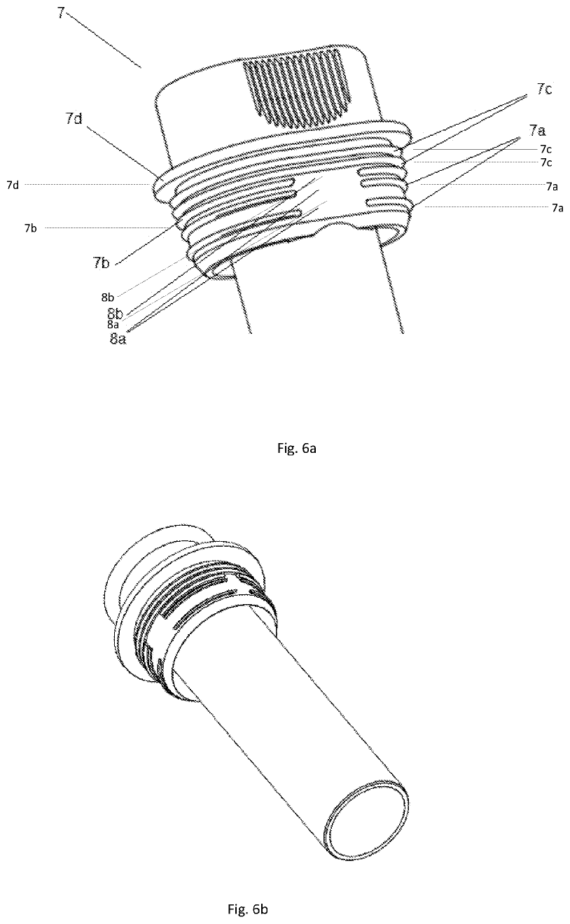

Optionally, the plug part 7 may have a circular shape as shown in FIG. 6b.

The syringe-plug 1 according to the invention may be made of various materials, preferably of polypropylene, polyethylene, polyurethane, polyvinyl, preferably in an injection moulding process.

FIG. 3 shows a perspective view of the microfluidic system 9 integrated with the sample chamber 10 of the cartridge 11 according to the present invention. The microfluidic system 9 comprises a schematically shown network 12 of microchannels leading to numerous incubation chambers.

The sample chamber 10 has an inlet 13 designed for introduction of the analyte sample S. The shape of the inlet 13 is designed so as to allow insertion of the syringe-plug 1 into the sample chamber 10. The inlet 13 of the sample chamber 10 has a shape corresponding to the shape of the plug part 7 of the syringe-plug 1 so that the inlet 13 may be closed by the same.

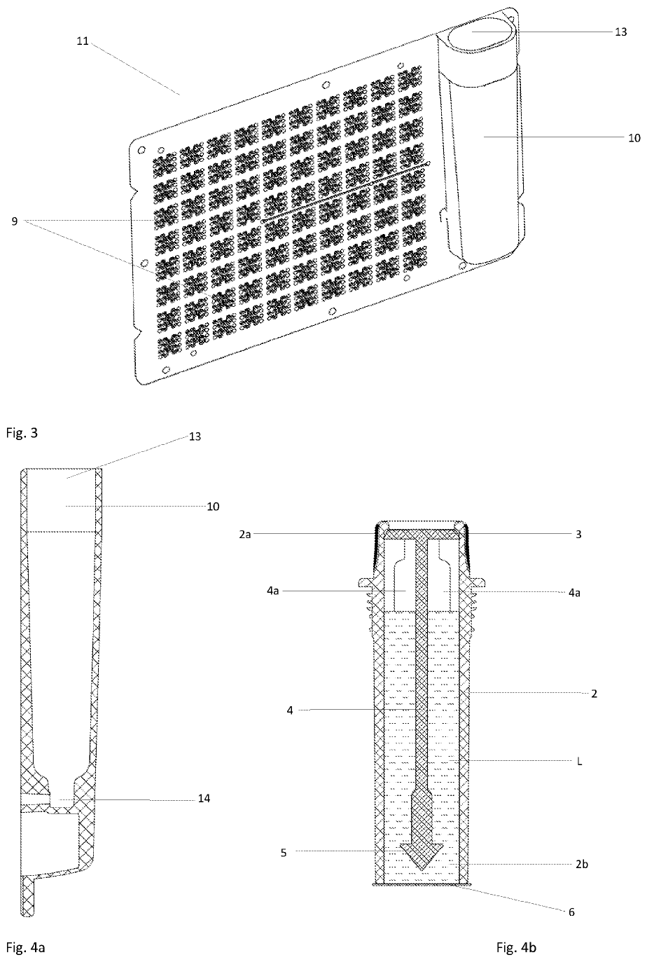

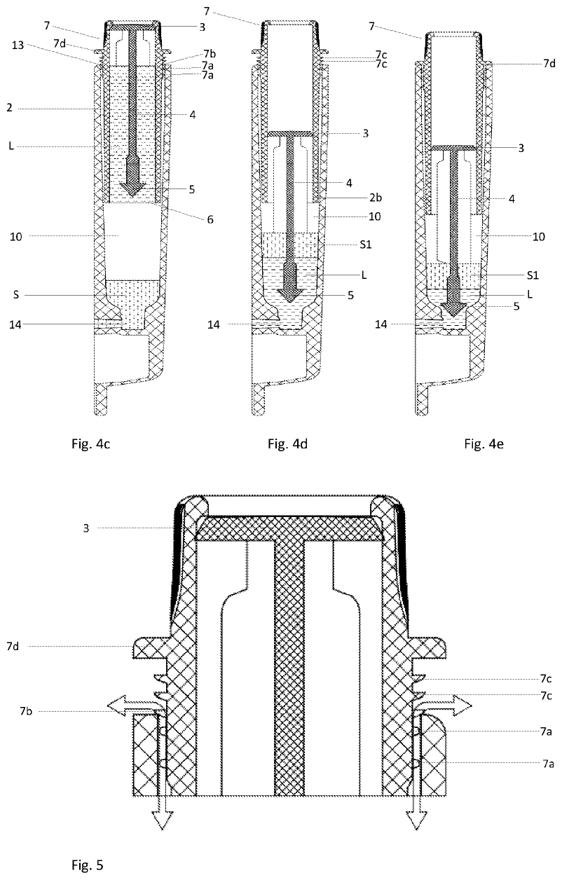

FIG. 4a shows a longitudinal section of an exemplary sample chamber 10. As mentioned above, it has an inlet 13 and an outlet 14 at the opposite end, the outlet 14 communicating with the network 12 of microchannels of the microfluidic system 9 (the connection is not shown in the figure).

FIG. 4b shows a longitudinal section of the syringe-plug 1, as assembled and filled with the separating liquid L, ready to be introduced into the sample chamber 10 through the inlet 13. As shown, at this stage the tank 2 is closed by the piston 3 at its proximal end 2a, while at its distal end 2b it is closed by the membrane 6. The piston 3 has a rod 4 on the distal side of the tank 2, the rod 4, over at least a part of its length, having preferably a cross-shaped cross-section with four arms 4a. The piercing part 5 is located at the free end of the rod 4, the shape of the piercing part 5 being preferably conical. The cross-shaped cross-section ensures an adequate stiffness of the rod 4.

The function of the rod 4 and the piercing part 5 will be explained in detail with reference to the process of filling the microfluidic system with the analyte sample S and the separating liquid L, to be described below.

The feeding of the microfluidic system 9 of the cartridge 11 for analytic assays with the analyte sample S and the separating liquid L from the integrated sample chamber 10 is preceded by introduction of the analyte sample S through the inlet 13 into the sample chamber 10.

Upon introduction of the analyte sample S into the sample chamber 10, the syringe-plug 1 comprising the tank 2 pre-filled with the separating liquid L is being inserted into the sample chamber 10 through the inlet 13.

FIG. 4c shows a longitudinal section of the sample chamber 10 after the first step of introduction of the syringe-plug 1 has been completed. In this first step, the syringe-plug 1 is being pushed manually by a diagnostician until a pronounced resistance appears, caused by the presence of the at least one retaining rib 7b on the plug part 7. The guiding ribs 7a assist in proper positioning of the syringe-plug 1 in the center of the inlet 13.

The function of the retaining rib 7b is to limit the depth of the possible manual insertion of the syringe-plug 1 into the inlet 13. As the guiding ribs 7a and the retaining rib 7b comprise the gaps 8a and 8b respectively (shown in more detail in FIG. 6), it is possible to ensure air flow into and out of the sample chamber 10 when the syringe-plug 1 has been inserted manually to the depth limited by the retaining rib 7b. Preferably, the gaps 8a and 8b on each of the ribs 7a and 7b are arranged opposite to each other on the circumference of the plug part 7, preferably on flat parts of said circumference (see also FIG. 6). There may be more gaps 8a, 8b.

Upon the first stage of the introduction of the syringe-plug 1 into the sample chamber 10, the cartridge 11 with the pre-installed syringe-plug 1 is being subjected to a sequence of varying pressures; this procedure is known in the art. This is possible in the case of the cartridge 11 due to the fact that the flow of air into and out of the sample chamber 10 is ensured through the ventilation gaps 8a, 8b located on the plug part 7 of the syringe-plug 1 according to the invention.

First, the cartridge 11 is subjected to a pressure in the range characteristic to the low vacuum as a result of which most of the air is removed both from the sample chamber 10 and from the microfluidic system 9. Next, the pressure is being raised. This results in the analyte sample S being pushed through the outlet 14, from the sample chamber 10, to the microfluidic system 9 so that the analyte sample S replaces the removed air. Once the microfluidic system 9 is filled with the analyte sample S and stabilized, the tank 2 of the syringe-plug 1 is being opened.

FIG. 4d shows a longitudinal section of the sample chamber 10 after the syringe-plug 1 has been introduced therein, the tank 2 has been opened and the separating liquid L has been released. In order to open the tank 2 the piston 3 must be pushed downwards (i.e. moved towards the distal end 2b) and the membrane 6 must be pierced. The piston 3 is pushed by a dedicated device used for filling one or more microfluidic systems 9 or by any other suitable device able to generate a pressure lower than the external pressure.

Immediately after the membrane 6 has been pierced, the surface tension of the separating liquid L maintains it inside the tank 2 of the syringe-plug 1. As mentioned above, the arms 4a of the rod 4 comprise indentations 4b. Their function is to vary the cross-section of tank outlet during the movement of the piston 3. This allows to break the surface tension forces in the separating liquid L and in consequence the emptying of the tank 2 is reliable and repeatable.

Once the indentations 4b of the rod arms 4a pass the membrane 6, the surface tension forces are broken and the separating liquid L flows out as water flows out of an upside down turned bottle. Considering that the separating liquid L is a non-polar liquid that is heavier than water, and that the water is the main component of the analyte sample S, once the separating liquid L has flown down into the sample chamber 10, it does not get mixed with a residue of the analyte sample S1 and it is collected instead in the lowest part of the sample chamber 10. The residue of the analyte sample S1 which has not been pushed into the microfluidic system 9 before floats on the surface of the separating liquid L, as shown in FIG. 4d.

The air from the sample chamber 10 replaces the “moving down” separating liquid L which causes the air move into the inside the tank 2 of the of the syringe-plug 1. The air (air bubbles) escapes through the residue of the analyte sample S1 contained in the tank 2 and it is released to the outside through the gaps 8a, 8b in the plug part 7 of the syringe-plug 1 which is not yet closed at this stage.

Once the separating liquid L and the residue of the analyte sample S1 have stabilized, the pressure is being raised again. This results in the separating liquid L being pushed through the outlet 14, from the sample chamber 10 to the microfluidic system 9. As disclosed in e.g. EP3546067, within the microfluidic system 9 the analyte sample S is being distributed between the incubation chambers. The pressure is being raised until it equals the outside pressure. Due to the fact that the air was previously sucked off the microfluidic system 9, the analyte sample S is being sucked in into the microfluidic system 9, a part of which is still not filled with the same.

The situation upon the first stage of introduction of the syringe-plug 1 into the sample chamber 10 is shown in more detail in FIG. 5, where the airflow channels formed by the gaps 8a, 8b are shown by arrows.

The cartridge 11 is ready to be hermetically closed once its contents has stabilized. The hermetical closing constitutes the second stage of the introduction of the syringe-plug 1 into the sample chamber 10. The effect of the second stage is shown in FIG. 4e.

In order to perform the second stage, i.e. the hermetic closing of the cartridge 11, the piston 3 of the syringe-plug 1 is pushed further towards the distal end 2b of the tank 2 by a dedicated device used for filling one microfluidic system or many microfluidic systems simultaneously or by any other suitable device able to generate a pressure lower than the outside pressure. At the same time, the syringe-plug 1 is pushed further into the sample chamber 10 (the second stage of introduction).

In order to push the syringe-plug 1 further, as far as to close the sample chamber 10 by the thrust flange 7d, the resistance of the retaining rib 7b and the sealing ribs 7c must be overcome. This may be achieved by applying a force that is importantly greater than the manual force used in the first stage of introduction. When the syringe-plug 1 is being pushed, the endings of the retaining rib 7b and of the sealing ribs 7c get deformed. Therefore, conveniently the sample chamber 10 is made of a material 16 having a Young's Modulus higher than that of the material of the syringe-plug 1 and its ribs. The dimensions of the ribs 7c are selected so that the ribs 7c provide tightness at junction.

As mentioned above, at the same time the piston 3 is being pushed; the piercing part 5 preferably of a conical shape, located at the free end of the rod 4, is being pushed into the outlet 14 of the sample chamber 10. The piercing part 5 is formed similarly to the sealing ribs 7c, i.e. it gets deformed once pushed into the outlet 14 and consequently the network 12 of channels of the microfluidic system 9 becomes separated from the sample chamber 10. The piercing part 5 of the rod 4 may also have a different shape (not shown in the drawing), e.g. of an obliquely truncated cylinder and it may be provided with a ring enabling to tightly close the outlet 14.

FIG. 6a shows in more detail a perspective view of an exemplary the syringe-plug 1 plug part 7 in the form of a flange having a substantially oval cross-section, so that it abuts the cylindrical tank 2 at its flat sides. The shape of the plug part 7 may be different but it must correspond to the shape of the inlet 13 of the sample chamber 10.

FIG. 6b shows a perspective view of another variant of the syringe-plug 1 plug part 7 in the form of a flange having a circular cross-section. In this case the inlet 13 or both the inlet 13 and the sample chamber 10 must have a corresponding circular cross-section.

As it results from the above description, the only operations to be performed manually by a diagnostician in order to feed the microfluidic system 9 with the analyte sample S and the separating liquid L, are to place the analyte sample S in the sample chamber 10 and to introduce the syringe-plug 1 in the inlet 13 of the sample chamber 10, and finally to place the cartridge 11 in a container of a dedicated device used for filling one or more microfluidic systems 9 or any other suitable device able to generate a pressure lower than the external pressure. The syringe-plug 1 according to the invention comprises a measured and sterile enclosed volume of the separating liquid L which allows to avoid contamination, manual dosing and introducing, and consequently to avoid errors caused by the manual filling of the cartridge with the separating liquid L.

Additionally, the pierceable membrane eliminates occurrence of a chemical reaction of a melting wax cap with reagents which could have impact on the results of the assays.

In view of the fact that it is advantageous to store and/or to use the syringe-plug according to the invention in a horizontal position (or generally in any position), it is important to ensure that the piston 3 is as tight against the tank 2 as possible, in particular when the piston is in its distal position. A proper sealing of the syringe-plug allows for storing it for a long time before it is used (a long shelf-life). The syringe-plug is stored with its piston 3 in the proximal position, pressing against the wall of the tank 2. Consequently, the piston 3 may get deformed which in turn may adversely affect its tightness because the pressure exerted on the wall of the tank 2 may decrease over time. The tightness of the piston 3 in its distal position may also be decreased as a consequence of the fact that the tank 2 may not be a perfect cylinder but its walls may be slanted by a very small degree (in the range of 0.1 degree) in such a way that the diameter of the tank 2 is minimally larger at its distal end. This may result from the manufacturing technology of the tank.

In view of the above, some other embodiments of the sample chamber and the syringe-plug according to the invention have been developed. In these below described embodiments, preferred features have been introduced in order to improve the sealing of the piston against the tank, in particular when the piston is in its distal position.

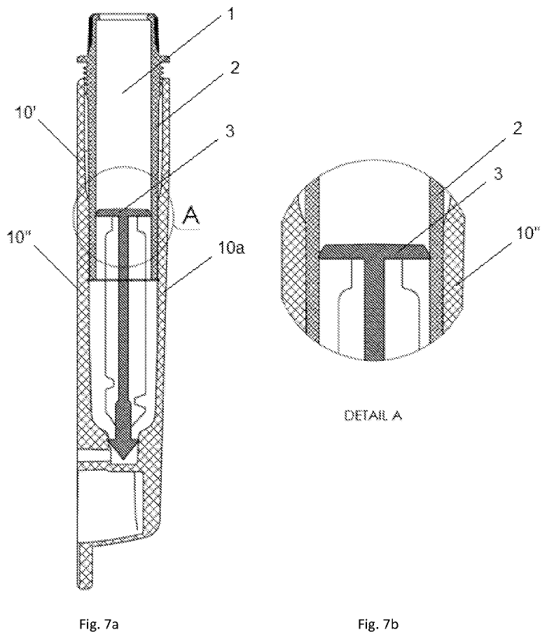

FIG. 7a shows a fragment of an optional variant of the sample chamber 10a with the syringe-plug 1 located within. In this variant, the wall of the chamber 10a is thicker in its distal part and thinner in its proximal part, i.e. the wall of the chamber 10a has two areas—the thinner proximal area 10′ and the thicker distal area 10″. The thickening in the area 10″ ensures that the tank 2 is pressed when the piston 3 is in its distal position which results in a greater pressure exerted by the piston 3 against the wall of the tank 2 which promotes the increase of tightness. Preferably, the thickening in the area 10″ may not be continuous so as to allow gas permeability between the tank 2 and the sample chamber 10a. If the thickening is not continuous it presses only on selected points of the circumference of the tank 2. FIG. 7b shows an enlarged detail A indicated in FIG. 7a.

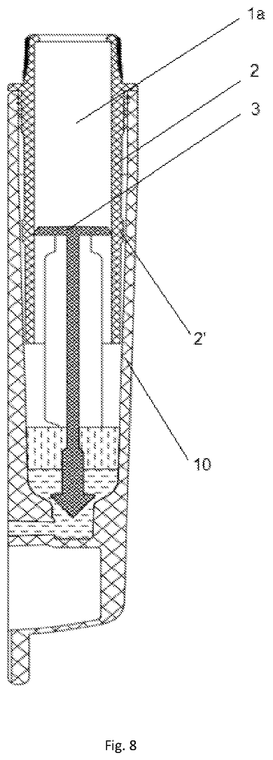

FIG. 8 shows a longitudinal section of the sample chamber 10 with the syringe-plug 1a according to a second embodiment. In this embodiment, the external wall of the tank 2 comprises an annular thickening 2′ located in the area corresponding to the distal position of the piston 3 which allows to increase the stiffness of the tank 2 and hence to improve its tightness. The thickening 2′ may consist of an additional ring made of the same material as the tank 2 and the whole syringe-plug 1a, in particular of polypropylene, polyethylene, polyurethane, polyvinyl.

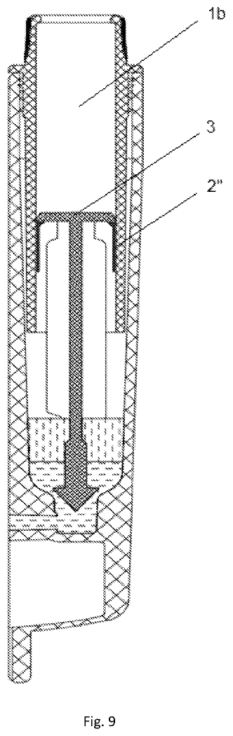

FIG. 9 shows a longitudinal section of the sample chamber with the syringe-plug 1b according to a third embodiment. In this embodiment the internal wall of the tank 2 comprises an additional sealing layer 2″. Said layer 2″ may be effaceable by the action of the moving piston 3 towards the distal direction so that the effaced layer 2″ accumulates near the piston 3 and seals it against the wall of the tank 2.

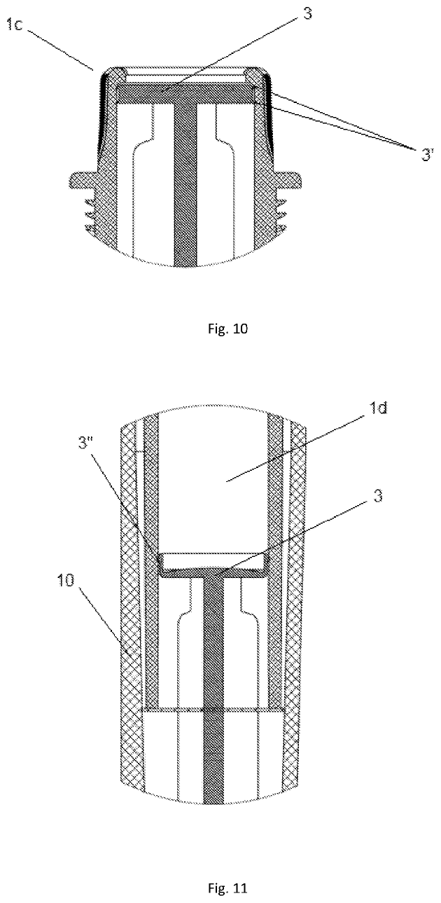

FIG. 10 shows a longitudinal section of an upper part of the syringe-plug 1c according to a fourth embodiment. In this embodiment, the periphery of the piston 3 is provided with two circumferential elastic lips 3′ made of the same material as the piston 3 or, alternatively, is made of elastomer. The lips 3′ constitute another means to improve the tightness of the piston 3 against the wall of the tank 2.

FIG. 11 shows a longitudinal section of a fragment of the sample chamber 10 with the syringe-plug 1d according to a fifth embodiment located within. In this embodiment the piston 3 is provided with an elastic flange 3″ extending in the proximal direction. Said flange 3″ is made of the same material as the piston 3 or is made of elastomer and it constitutes a thin elastic extension of the piston periphery so as to form a “cup-like” shape. This feature enables to obtain larger deformations of the piston material, simultaneously maintaining smaller stress.

1. A syringe-plug for placement in a sample chamber of a cartridge for analytic assays, the syringe-plug comprising a tank pre-filled with a liquid, the tank having a proximal end and a distal end, the proximal end of the tank being closed by a piston movable towards said distal end, the distal end of the tank being closed by a pierceable membrane and the piston being provided on the distal end side with a rod having a piercing part at its end enabling to pierce the membrane, wherein the proximal end of the tank is provided with a plug part surrounding the proximal end of the tank, the plug part comprising external sealing means in the form of: at least one retaining rib surrounding a part of the plug part circumference and comprising at least one gap; at least one sealing rib surrounding the whole plug part circumference; a thrust flange extending to the outside of the plug part by a distance larger than the retaining rib(s) and the sealing rib(s), said sealing means being arranged sequentially as seen from the distal end side of the tank.

2. The syringe-plug according to claim 1, wherein each retaining rib comprises two mutually opposite gaps.

3. The syringe-plug according to claim 1, wherein each retaining rib and each sealing rib are susceptible to plastic/elastic deformations.

4. The syringe-plug according to claim 1, wherein the plug part further comprises at least one guiding rib located upstream of said at least one retaining rib as seen from the distal end side of the tank, the guiding rib surrounding a part of the plug part and comprising at least one gap and extending to the outside of the plug part by a distance smaller than said at least one retaining rib.

5. The syringe-plug according to claim 1, wherein the plug part comprises two sealing ribs.

6. The syringe-plug according to claim 1, wherein the plug part comprises two guiding ribs.

7. The syringe-plug according to claim 1, wherein the piston rod has a cross-shaped cross-section over at least a part of its length, at least one arm of the cross comprising at least one indentation.

8. The syringe-plug according to claim 1, wherein the piercing part of the rod has a shape of a cone.

9. The syringe-plug according to claim 1, wherein the piercing part of the rod has a shape of a cylinder with a slanted end.

10. A cartridge for analytic assays comprising a sample chamber integrated with a microfluidic system, the microfluidic system being fed with a sample of analyte and with a separating liquid, the sample chamber having an inlet adapted for insertion of the sample of analyte, the cartridge further comprising the syringe-plug according to claim 1 comprising a tank pre-filled with the separating liquid.

11. The cartridge according to claim 10, wherein the sample chamber has an outlet at its end opposite to the inlet, the outlet communicating with the microfluidic system for feeding the sample of analyte and the separating liquid into said microfluidic system.

12. The cartridge according to claim 10, wherein the tank is adapted to take a first position or a second position in the sample chamber, wherein in the first position the plug part partly closes the inlet of the sample chamber, and in the second position the plug part tightly closes the inlet of the sample chamber.

13. The cartridge according to claim 10, wherein each retaining rib and each sealing rib are susceptible to plastic/elastic deformations.

14. The cartridge according to claim 10, wherein the plug part further comprises at least one guiding rib located upstream of said at least one retaining rib as seen from the distal end side of the tank, the guiding rib surrounding a part of the plug part and comprising at least one gap and extending to the outside of the plug part by a distance smaller than said at least one retaining rib.

15. The cartridge according to claim 10, wherein the plug part comprises two sealing ribs.

16. The cartridge according to claim 10, wherein the plug part comprises two guiding ribs.

17. The cartridge according to claim 10, wherein the piston rod of the syringe-plug has a cross-shaped cross-section over at least a part of its length, at least one arm of the cross comprising at least one indentation.

18. The cartridge according to claim 10, wherein the piercing part of the piston rod has a shape of a cone corresponding to the shape of the outlet of the sample chamber, so as to constitute a tight closure of said outlet.

19. The cartridge according to claim 18, wherein the piercing part of the rod has a shape of a cylinder with a slanted end.
